(19) United States
(12) Patent Application Publication
(10) Pub. No.: US 2024/0267707 A1
(43) Pub. Date: Aug. 8, 2024

(54) SYSTEM AND METHOD FOR MULTI-MODE RF SCANNING

(71) Applicant: N-SMART INC., Sterling, VA (US)

(72) Inventors: Kiran Yeddala, Great Falls, VA (US); Harsh Kapil, Herndon, VA (US); Anu Juneja, Alexandria, VA (US)

(21) Appl. No.: 18/430,322

(22) Filed: Feb. 1, 2024

Related U.S. Application Data
(60) Provisional application No. 63/483,055, filed on Feb. 3, 2023.

(51) Int. Cl. H04W 4/029; G01S 1/02; G01S 1/04

(52) U.S. Cl. CPC H04W 4/029; G01S 1/024; G01S 1/047

(57) ABSTRACT

The disclosed is a tracking system comprises RF tags/beacons and a Hub (Parent Node) (100) for centralized control, with Bi-directional serial communication (101) linking the Parent Node to Wireless Nodes (Child Nodes) (102). Data transfer occurs via a Cellular Network (106) to a cloud-based system featuring a user interface (108) for user instructions and result display, a Database (111) for storing asset data, and an Analytics Engine (110) for organizing data based on received asset-related information. The system ensures precise monitoring and scanning of RF tags/beacons for enhanced tracking accuracy. The present disclosure also relates to a method for asset tracking by way of the tracking system (10).

### TECHNICAL FIELD

The present invention generally relates to radio frequency identification (RFID) used in tracking locations of asset and more particularly automatic tracking the presence and/or absence of multiple assets using RF tags in a stationary or mobile state and stored in various enclosed high attenuation Environment.

### BACKGROUND

Short Range wireless tags have limited transmission when they are in enclosed environments like metal boxes or cabinets. Being in metal cabinets creates a Faraday cage kind of situation resulting in high attenuation which leads to loss of propagation and signal damping.

The RF tags can be both passive and active. The active tags are battery powered and operate on different power levels and transmission intervals based on the use case. In the case of enclosed environments, the signal transmission and propagation are constrained. As a result, the RF tags need to be operated at highest power levels, and short transmission intervals, to get the most reliable output out of each scanning cycle. This heavily impacts the battery life of the tags and makes it impossible to deploy in an operational environment as it would require frequent replacement of the battery or the tags.

In an ideal scenario, for the solution to be scalable, the tags that are enclosed in attenuated environments should have optimized power levels and transmission intervals to conserve the battery.

It is desirable, therefore, to provide a system and method that increases the accuracy of monitoring and scanning of the RF tags, to transmit the position information of an asset (RF Tagged tools and devices) in any given location. It is further desirable to improve the accuracy of RF tag location monitoring when one or more RF tags are present in high attenuation enclosed spaces to avoid duplicate data and inaccurate readings. It is also desirable to track assets inexpensively, accurately, and automatically (without human involvement), and to differentiate between ownership of multiple RF tagged assets by a single system within a single stationary or mobile geographic location.

Accordingly, there exists a need for a system and method for real time location monitoring of assets using RF tag, which even provides location of tagged assets under attenuation environment.

### SUMMARY

In one aspect of the present disclosure, an asset tracking system is provided.

The tracking system includes a plurality of RF tags/beacons and Hub (Parent Node) that are adapted to asset identification and tracking facilitating a centralized control and communication hub respectively. The tracking system further includes Bi-directional serial communication that adapted to establish a link between the Parent Node and a plurality of Wireless Nodes (Child Nodes). The tracking system further includes a Cellular Network that is adapted to transfer the data across the hub and a cloud-based system. The tracking system further includes a cloud-based system that is communicatively coupled with the hub. The cloud-based system includes a user interface that is adapted to receive one or more instructions from a user and display one or more result with the user. The cloud-based system further includes a Database that may be adapted for storing asset-related data. The cloud-based system includes an Analytics Engine for that is adapted for transforming and organizing data based on the received asset-related data, where the system enables accurate monitoring and scanning of RF tags/beacons to enhance tracking precision.

In some aspects of the present disclosure, the system ensures precise location determination even in the presence of multiple RF tags/beacons.

In some aspects of the present disclosure, the system avoids duplication of data and inaccuracies in readings associated with asset location and tags.

In some aspects of the present disclosure, the system automates asset location, reporting, and differentiation among multiple RF-tagged assets without human intervention.

In some aspects of the present disclosure, the system utilizes a Hub structure and Cloud for data processing via Cellular backhaul.

In some aspects of the present disclosure, the system collects, transfers, processes, employs analytic techniques, and displays information on the Portal in a user-desired format.

In some aspects of the present disclosure, the system comprises the Parent Node, Child Nodes, and Bi-directional serial communication for wireless interconnection, cellular network link, data processing, and synchronization with the Cloud Database.

In second aspect of the present disclosure a method for asset tracking is provided.

The method include identifying and tracking assets using a plurality of RF tags/beacons and a Hub (Parent Node) providing centralized control and communication. The method further includes establishing communication between the Parent Node and a plurality of Wireless Nodes (Child Nodes) via Bi-directional serial communication. The method further includes transferring data across a Cellular Network between the Hub and a Cloud-based system. The method further includes receiving instructions from a user via a user interface and displaying corresponding results by way of the cloud-based system. The method further includes storing asset-related data in a Database by way of the cloud-based system. The method further includes transforming and organizing data utilizing an Analytics Engine based on received asset-related data by way of the cloud-based system, wherein the method enables accurate monitoring and scanning of RF tags/beacons to enhance tracking precision.

In some aspects of the present disclosure, the method further includes determining precise asset location even in the presence of multiple RF tags/beacons.

In some aspects of the present disclosure, the method further includes preventing data duplication and inaccuracies in readings associated with asset location and tags.

### BRIEF DESCRIPTION OF THE DRAWINGS

The manner in which the features, advantages and objects of the invention, as well as others which will become apparent, may be understood in more detail, more particular description of the invention briefly summarized above may be had by reference to the embodiment thereof which is illustrated in the appended drawings, which form a part of this specification. It is to be noted, however, that the drawings illustrate only a preferred embodiment of the invention and is therefore not to be considered limiting of the invention's scope as it may admit to other equally effective embodiments.

FIG. 1 illustrates schematic representation of system and method of extending RF Scanning in a high attenuation environment.

FIG. 2 illustrates schematic representation of process of data and on display.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, known details are not described in order to avoid obscuring the description.

References to one or an embodiment in the present disclosure can be references to the same embodiment or any embodiment; and, such references mean at least one of the embodiments.

Reference to “one embodiment”, “an embodiment”, “one aspect”, “some aspects”, “an aspect” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided.

A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification. Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

The terms “portal” and “user interface” are used interchangeably across the context of the specification.

The tracking system (10) may include a plurality of RF tags/beacons and a Hub (Parent Node) (100) that are adapted to asset identification and tracking facilitating a centralized control and communication hub respectively.

The tracking system (10) may further include a Bi-directional serial communication (101) this adapted to establish a link between the Parent Node (100) and a plurality of Wireless Nodes (Child Nodes) (102).

The tracking system (10) may further include a Cellular Network (106) that is adapted to transfer the data across the hub and a cloud-based system.

The tracking system (10) may further include a cloud based system that is communicatively coupled with the hub (100).

The tracking system (10) may further include an user interface (108) that is adapted to receive one or more instructions from a user and display one or more result with the user;

The tracking system (10) may further include a Database (111) that may be adapted for storing asset-related data;

The tracking system (10) may further include an Analytics Engine (110) for that is adapted for transforming and organizing data based on the received asset-related data;

In some aspects of the present disclosure, the system (10) enables accurate monitoring and scanning of RF tags/beacons to enhance tracking precision.

In some aspects of the present disclosure, the system (10) ensures precise location determination even in the presence of multiple RF tags/beacons.

In some aspects of the present disclosure, the system (10) avoids duplication of data and inaccuracies in readings associated with asset location and tags.

In some aspects of the present disclosure, the system (10) automates asset location, reporting, and differentiation among multiple RF-tagged assets without human intervention.

In some aspects of the present disclosure, the system (10) utilizes a Hub structure and Cloud for data processing via Cellular backhaul.

In some aspects of the present disclosure, the system (10) collects, transfers, processes, employs analytic techniques, and displays information on the Portal in a user-desired format.

In some aspects of the present disclosure, the Hub (100) comprises the Parent Node, Child Nodes, and Bi-directional serial communication for wireless interconnection, cellular network link, data processing, and synchronization with the Cloud Database (111).

In second aspect of the present disclosure, a method for asset tracking is provided.

At step A, the system 10 is configured to identify and tracking assets using a plurality of RF tags/beacons and a Hub (Parent Node) (100) providing centralized control and communication.

At step B, the system 10 is configured to stabilize communication between the Parent Node (100) and a plurality of Wireless Nodes (Child Nodes) (102) via CANBUS Integration (101).

At step C, the system 10 is configured to transfer data across a Cellular Network (106) between the Hub and a Cloud-based system.

At step D, the system 10 is configured to receive instructions from a user via a user interface (108) and displaying corresponding results by way of the cloud-based system.

At step E, the system 10 is configured to storing asset-related data in a Database (111) by way of the cloud-based system.

At step F, the system 10 is configured to transforming and organizing data utilizing an Analytics Engine (110) based on received asset-related data by way of the cloud-based system, wherein the method enables accurate monitoring and scanning of RF tags/beacons to enhance tracking precision.

At step G, the system 10 is configured to determine precise asset location even in the presence of multiple RF tags/beacons.

At step H, the system 10 is configured to prevent data duplication and inaccuracies in readings associated with asset location and tags.

The present invention relates generally to automatic tracking the presence and/or absence of multiple assets using RF tags in a stationary or mobile state and stored in various enclosed locations. More particularly, the present invention is a hardware and system, comprising combination of a parent node (100) with child nodes (102) to extend the passive RF scanning range within the proximity of short-range RF emitters.

In one embodiment, the present invention provides users with the accurate tracking of assets or equipment on a map.

To accomplish this functionality in a closed environment multiple active radio frequency (RF) devices are placed with the assets which emit signal or beacon. child nodes (102) are placed in the range of signal and those child nodes receive the signal received from the nearby or in emit range of RF tags or beacon. The received information by the child nodes are transmitted to the parent node (100).

wherein child nodes comprises of multiple individual nodes which are interconnected to each other nodes via Bi-directional serial communication and each node under the child node receives the signal emitted from the RF tags and transfer the information to the parent node[100], which are connected with the child node wirelessly.

Parent Node(100) acts as an aggregator as well as cloud gateway for the information gathered from RF emitters by the child nodes (102) using Bi-directional serial communication (101) and transmits that data to the centralized cloud database (111). wherein the parent node comprises of CAN, Cellular Modem, wireless medium, GPS, and battery. Such that the wireless medium to connect and retrieve information from child node and cellular modem to transfer the information to the hub is selected from RFID (radio frequency identification) or BLE (bluetooth low energy) or UWB (ultra-wide band), where the information is stored in the cloud and processed then displayed in a desired manner on a portal (108), such that the tagged object or asset can be shown geographically.

These received information and logs are synced with cloud database (111) using the cellular network (106), where this data is then converted to information with data processing (109) and the analytics engine (110) further uses this information to provide meaningful insights out of the data collected for data-driven business decision making processes.

In some aspects of the present disclosure aims to address the problems stated above by introducing an IoT hub equipped with extended sensory nodes resembling tentacles. This system is designed with a focus on wired connectivity, making it particularly suitable for reliable data transmission in industrial, outdoor, and utility environments.

In some aspects of the present disclosure, the nodes can support various types of sensors, such as smoke detectors, temperature sensors, and many more, providing flexibility and adaptability. The hub also serves as an edge computing device, enabling local data processing to significantly reduce latency and enhance real-time responsiveness.

In some aspects of the present disclosure, the system facilitates cellular backhaul, ensuring robust communication with a centralized network or cloud service, even in remote or challenging environments. Moreover, the system is designed to receive remote updates, allowing for seamless enhancement of system functionality post-deployment.

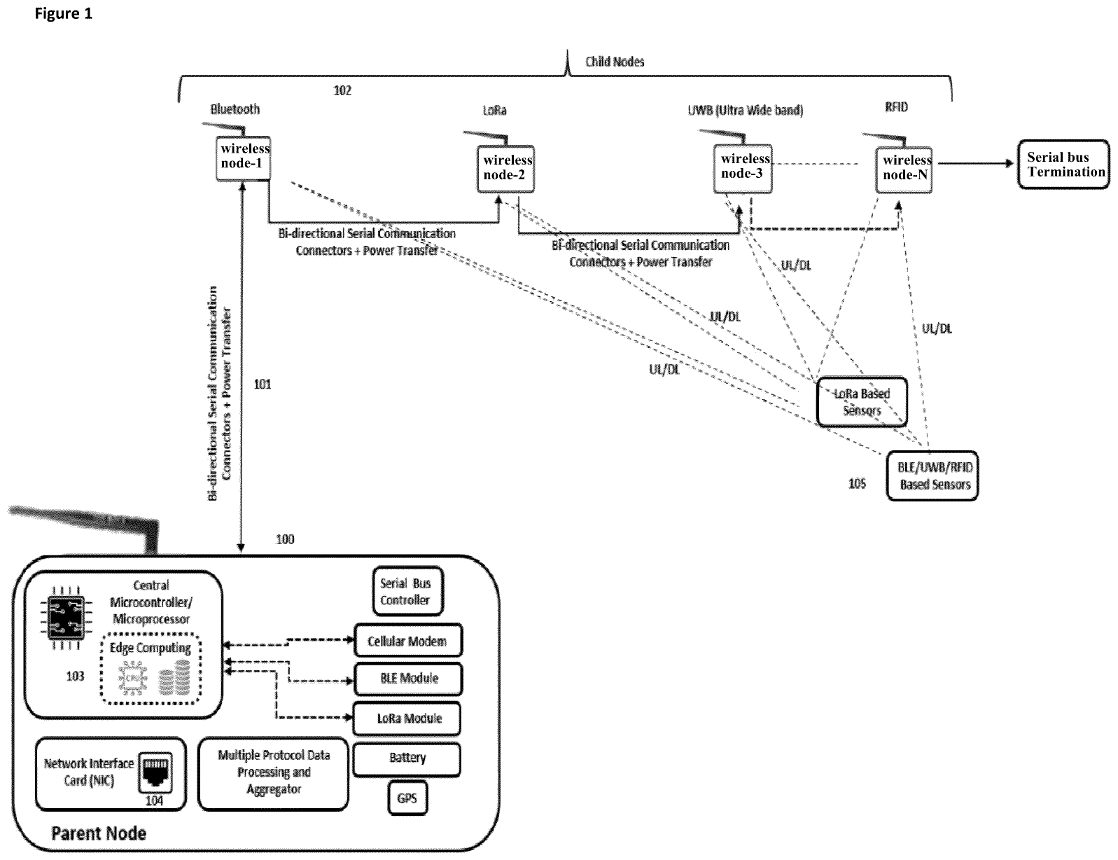

As depicted in FIG. 1, the innovative hub or gateway [100] is conceptualized as a central unit connecting to multiple sensor nodes [102]. Each node extends outward in the form of a tentacle, allowing for strategic placement in different zones of an industrial, outdoor, or utility setting. The nodes [102] are designed to accommodate a variety of sensor types [105], as per the specific requirements of the deployment.

The sensor nodes [102] primarily communicate with the central hub [100] using wired protocols (101), as shown in FIG. 1. This primary wired connectivity ensures that the hub operates optimally across a diversity of environments, ensuring the consistent and efficient collection of sensor data. Moreover, the system is designed to switch or combine wired connectivity with wireless communication technologies, such as Cat-M, LoRa, and BLE, as needed, based on the specific requirements of the deployment.

The hub's inbuilt edge computing capabilities [103] enable the on-site processing of collected data, reducing the amount of data that needs to be transmitted and mitigating latency. This feature is particularly crucial in applications where real-time responsiveness is paramount. Additionally, the hub [100] functions as a cellular backhaul, as shown in FIG. 1. This feature enables data communication to a centralized network or cloud service, further enhancing the versatility and robustness of the solution.

The hub [101] and sensory nodes [102] are powered by customizable firmware and software designed to handle diverse sensor data, manage the wired and wireless connectivity options, and conduct the necessary edge computations [103].

The processed data can then be sent via a Network Interface Controller (NIC) (104) to local networks, equipped to manage various networking standards and protocols, ensuring secure and efficient data transmission. The data can be transmitted to a cellular network (106) and subsequently via the internet (107) to a centralized database (111).

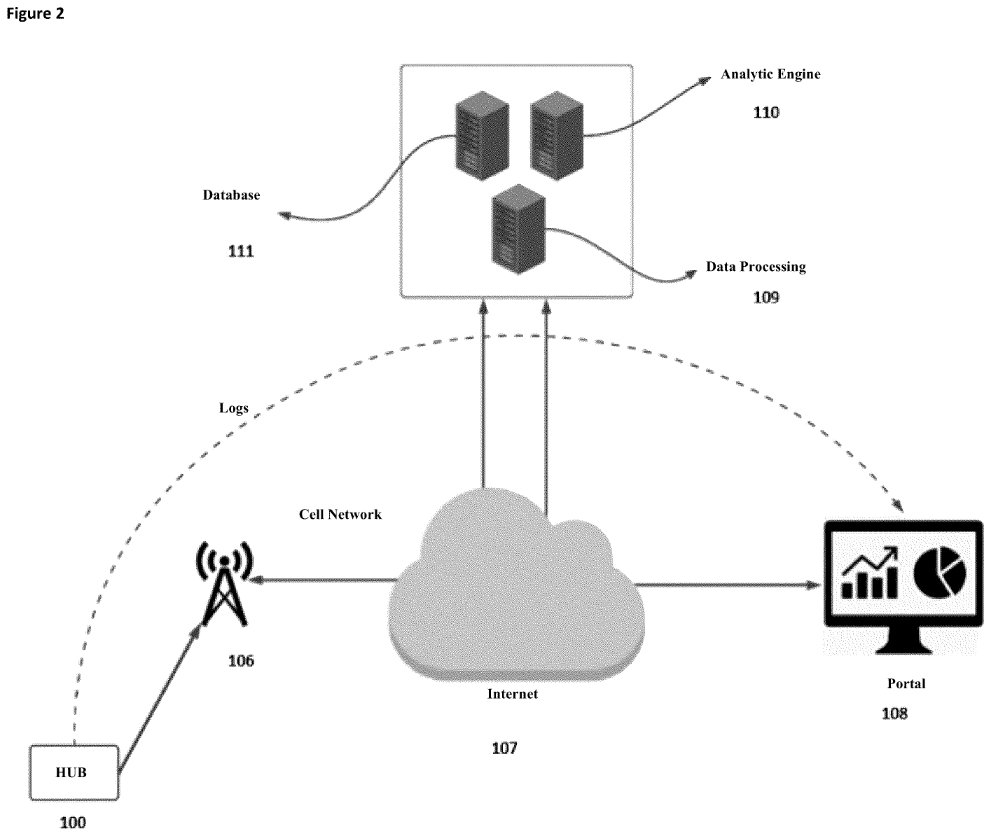

The collected data is further processed and analyzed by a robust analytics engine (110), which offers insights based on the data. The data is then further refined by a data processing module (109), which helps extract relevant information for the specific application as shown in FIG. 2. This processed data is finally presented on an application portal (108). The portal provides a user-friendly interface for real-time updates and system management.

In conclusion, this invention represents a substantial advancement in the field of Industrial IoT. It provides a solution that is versatile, reliable, and intelligent, addressing many of the shortcomings of traditional IoT systems. With its unique combination of multi-technology support, wired connectivity,

edge computing, and remote update capabilities, it sets a new benchmark in IoT technology, making it the ideal choice for industrial, outdoor, and utility applications. By addressing the highlighted problems, this invention ushers in a new era of IoT solutions, effectively revolutionizing the way we manage and deploy IoT technology across various industries.

The implementation set forth in the foregoing description do not represent all implementations consistent with the subject matter described herein. Instead, they are merely some examples consistent with aspects related to the described subject matter. Although a few variations have been described in detain above, other modifications or additions are possible. In particular, further features and/or variations can be provided in addition to those set forth herein. For example, the implementation described can be directed to various combinations and sub combinations of the disclosed features and/or combinations and sub combinations of the several further features disclosed above.

In addition, the logic flows depicted in the accompanying figures and/or described herein do not necessarily require the particular order shown, or sequential order, to achieve desirable results. Other implementations may be within the scope of the following claims.

1. A tracking system (10) comprising:
a. A plurality of RF tags/beacons and Hub (Parent Node) (100) that are adapted to asset identification and tracking facilitating a centralized control and communication hub respectively;
b. Bi-directional serial communication (101) this adapted to establish a link between the Parent Node (100) and a plurality of Wireless Nodes (Child Nodes) (102);
c. a Cellular Network (106) that is adapted to transfer the data across the hub and a cloud-based system;
d. a cloud based system that is communicatively coupled with the hub (100), the cloud-based system comprises:
i. an user interface (108) that is adapted to receive one or more instructions from a user and display one or more result with the user;
ii. a Data processing (109) that is adapted to process the data received data from nodes into information;
iii. a Database (111) that may be adapted for storing asset-related data;
iv. an Analytics Engine (110) for that is adapted for transforming and organizing data based on the received asset-related data;
Wherein the system enables accurate monitoring and scanning of RF tags/beacons to enhance tracking precision.

2. The tracking system (10) of claim 1, wherein the system (10) ensures precise location determination even in the presence of multiple RF tags/beacons.

3. The tracking system (10) of claim 1, wherein the system (10) avoids duplication of data and inaccuracies in readings associated with asset location and tags.

4. The tracking system (10) of claim 1, wherein the system (10) automates asset location, reporting, and differentiation among multiple RF-tagged assets without human intervention.

5. The tracking system (10) of claim 1, wherein the system (10) utilizes a Hub structure and Cloud for data processing via Cellular backhaul.

6. The tracking system (10) of claim 1, wherein the system (10) collects, transfers, processes, employs analytic techniques, and displays information on the Portal in a user-desired format.

7. The system (10) of claim 1, wherein the Hub (100) comprises edge computing capabilities [103], Network Interface Controller (NIC) [104] and Bi-directional serial communication for wireless interconnection are linked via cellular network [106] for data processing [109], and synchronization with the Cloud Database (111).

8. A method for asset tracking comprising:
a. identifying and tracking assets using a plurality of RF tags/beacons and a Hub (Parent Node) (100) providing centralized control and communication;
b. establishing communication between the Parent Node (100) and a plurality of Wireless Nodes (Child Nodes) (102) via Bi-directional serial communication (101);
c. transferring data across a Cellular Network (106) between the Hub and a Cloud-based system;
d. receiving instructions from a user via a user interface (108) and displaying corresponding results by way of the cloud-based system;
e. storing asset-related data in a Database (111) by way of the cloud-based system; and
f. transforming and organizing data utilizing an Analytics Engine (110) based on received asset-related data by way of the cloud-based system, wherein the method enables accurate monitoring and scanning of RF tags/beacons to enhance tracking precision.

9. The method of claim 8, further comprising determining precise asset location even in the presence of multiple RF tags/beacons.

10. The method of claim 9, further comprising preventing data duplication and inaccuracies in readings associated with asset location and tags.
